(19) United States
(12) Patent Application Publication
(10) Pub. No.: US 2021/0393016 A1
(43) Pub. Date: Dec. 23, 2021

(54) PERSONAL-CARE-PRODUCT DISPENSING CONTAINER

(71) Applicants: Ann Marie Down, Lynnwood, WA (US); Carlos Alfredo Arias Echeverria, Lynnwood, WA (US)

(72) Inventors: Ann Marie Down, Lynnwood, WA (US); Carlos Alfredo Arias Echeverria, Lynnwood, WA (US)

(21) Appl. No.: 17/347,120

(22) Filed: Jun. 14, 2021

Related U.S. Application Data
(60) Provisional application No. 63/041,899, filed on Jun. 20, 2020.

(51) Int. Cl. A45D 34/04; A47K 5/12

(52) U.S. Cl. CPC A45D 34/04; A45D 2034/007; A47K 5/1205

(57) ABSTRACT

The current document is directed to personal-care-product dispensing containers that are space-efficient and convenient to use, particularly in automobiles and other vehicles. In one implementation, a hand-sanitizer dispensing container is incorporated into a cup holder that can be inserted into a standard cup holder within an automobile or other vehicle. In this way, the hand-sanitizer dispensing container is well anchored and available for convenient use, but does not occupy the cup holder in a way that prevents its use for holding cups, takes up very little space, and does not contribute to clutter or represent a management problem. Additional implementations include multiple dispensing containers incorporated within a single cup holder that can be used to contain and dispense various different types of lotions, solutions, liquids, and gels.

### CROSS REFERENCE TO RELATED APPLICATION

This application claims the benefit of Provisional Application No. 63/041,899, filed Jun. 20, 2020.

### TECHNICAL FIELD

The current document is directed to dispensing containers and, in particular, to a convenient and space-efficient personal-care-product-dispensing container.

### BACKGROUND

Various different types of anti-microbial hand sanitizers have become popular, over the past several decades, for personal hygiene. Modern alcohol-based hand sanitizers were first introduced in hospitals and clinics in the 1960s. Beginning in the 1980s, commercial hand-sanitizer products became available for consumers and, due to the current Covid-19 pandemic, the use of hand sanitizers has greatly expanded as a means for inhibiting transmission of the Covid-19 virus. The primary ingredient in many hand sanitizers is alcohol, often one or more of ethanol, isopropanol, and n-propanol. Hand sanitizers may contain additional ingredients, including water, glycerol, benzalkonium chloride, quaternary ammonium cations, hydrogen peroxide, and triclosan.

It is now common for hand sanitizer to be carried in pockets and purses as well as in automobiles and other vehicles. However, as with many small personal items, it is often difficult and inconvenient to keep hand-sanitizer containers at hand in automobiles. The small bottles are easily misplaced and often fall or roll due to the motion of the automobile, leading to unavailability of the hand sanitizer when needed for sanitizing hands after receiving receipts and change during toll-booth interactions, after transactions at drive-through vending establishments, and in other situations. The multitude of small items that are commonly carried by automobile drivers and passengers can lead to clutter and confusion within confined vehicle spaces. Overturned and misplaced hand-sanitizer containers may leak onto upholstery, carpets. and the surfaces of glove-box compartments. These problems are also associated with other types of personal-care lotions, solutions, liquids, and gels, including sunscreen, hand lotions, and other such products. Manufacturers, vendors, and consumers of these products continue to seek more convenient devices and the methods for dispensing the products and keeping the products at hand while traveling in vehicles.

### SUMMARY

The current document is directed to personal-care-product dispensing containers that are space-efficient and convenient to use, particularly in automobiles and other vehicles. In one implementation, a hand-sanitizer dispensing container is incorporated into a cup holder that can be inserted into a standard cup holder within an automobile or other vehicle. In this way, the hand-sanitizer dispensing container is well anchored and available for convenient use, but does not occupy the cup holder in a way that prevents its use for holding cups, takes up very little space, and does not contribute to clutter or represent a management problem. Additional implementations include multiple dispensing containers incorporated within a single cup holder that can be used to contain and dispense various different types of lotions, solutions, liquids, and gels.

### BRIEF DESCRIPTION OF THE DRAWINGS

FIGS. 1A-C illustrate one implementation of the currently disclosed personal-care-solution dispensing container.

FIG. 2 shows a cross-section view illustrates of one implementation of the currently disclosed personal-care-solution dispensing container.

FIG. 3 shows a multi-solution implementation of the currently disclosed personal-care-solution dispensing container using the same illustration conventions as used in FIG. 2.

FIGS. 4A-B illustrate the tops of the single-solution and multi-solution implementations of the currently disclosed personal-care-solution dispensing container shown in FIGS. 2 and 3.

FIGS. 5A-D illustrate operation of the liquid-dispensing pump assembly.

### DETAILED DESCRIPTION

The current is directed to personal-care-liquid dispensing containers that are space-efficient and convenient to use, particularly in automobiles and other vehicles. These dispensing containers are useful for containing and dispensing hand sanitizer, but may also be used for dispensing sunscreen and other personal-care products.

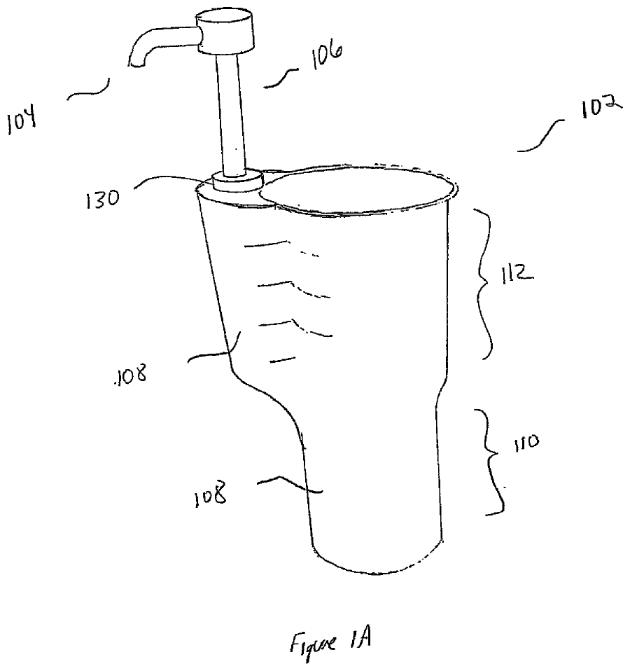

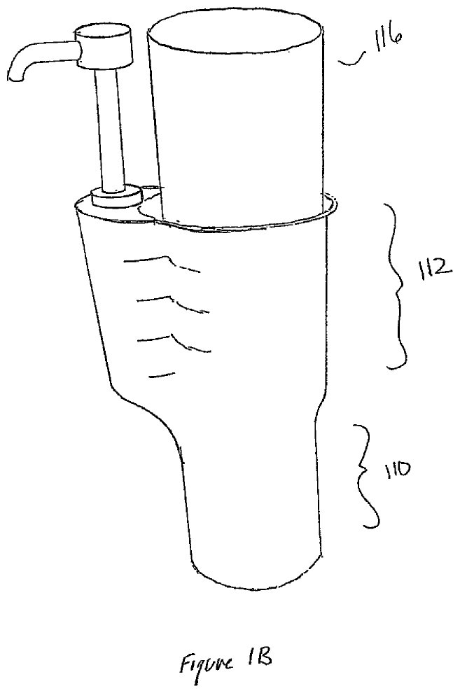

FIGS. 1A-C illustrate one implementation of the currently disclosed personal-care-solution dispensing container. As shown in FIG. 1A, the dispensing container 102 includes a dispenser outlet 104 from a plunger-type liquid-dispensing pump handle 106 mounted above a reservoir 108 that contains a lotion, solution, liquid, or gel dispensed by operation of the pump handle 106. The bottom portion of the personal-care-solution dispensing container 110 has a cylindrical or tapered-cylindrical shape with dimensions that are compatible with standard cup holders provided in automobiles and other vehicles. The personal-care-solution dispensing container 102 prominently includes a cup holder 112 into which a cup can be inserted.

FIG. 1B shows a cup 116 inserted into the cup holder 112 of the personal-care-solution dispensing container 102 shown in FIG. 1A. The cup holder 112 of the personal-care-solution dispensing container is sized to accommodate the same types and sizes of cups that are accommodated by the standard cup holder into which the bottom portion 110 of the personal-care-solution dispensing container is inserted. In certain implementations, an additional adapter can be used to adapt the bottom portion of the personal-care-solution dispensing container to different types of cupholders ith different dimensions. The adapter may be a foam sleeve, a rigid cup-like adapter, one or more foam pads, or even a mechanical adapter with mechanical features to secure the personal-care-solution dispensing container within a cup holder provided in an automobile or other vehicle. FIG. 1C illustrates the personal-care-solution dispensing container 102 shown in FIG. 1B inserted into an automobile cup holder 120. As shown in FIG. 1C, the personal-care-solution dispensing container 102 is securely mounted within the automobile cup holder and provides the same cup-holding functionality as the automobile cup holder within which it is mounted. Thus, the volume of the container and pump dispenser is quite efficiently accommodated without deleteriously impacting the functionality of the automobile cup holder or cluttering the vehicle interior. In addition, the personal-care-solution dispensing container is sufficiently well anchored to permit one-handed use. In alternative implementations, the personal-care-solution dispensing container is shaped to fit into other types of cavities, volumes, or apertures accessible to occupants of an automobile. residence, airplane, train, or other such vehicles and spaces occupied by people, whether or not originally intended to serve as cupholders, including, for example, openings in counter tops or tabletops.

The currently disclosed personal-care-solution dispensing container provides additional advantages. One advantage is that the reservoir is relatively voluminous, allowing a consumer to purchase hand sanitizer and other personal-care solutions in bulk, generally with significant savings. Returning to FIG. 1A, the dispensing pump assembly is removably affixed to the container and cup holder by a threaded cap 130. The cap can be unthreaded and removed, allowing the dispensing pump assembly to be lifted out from the container to allow for convenient refilling of the reservoir. In alternative implementations, the top surface to which the pump is mounted may be removeable, to provide a larger opening through which to refill the reservoir. Purchasing hand sanitizer and other personal-care solutions in bulk, of course, eliminates wasteful discarding of small, single-use containers in landfills.

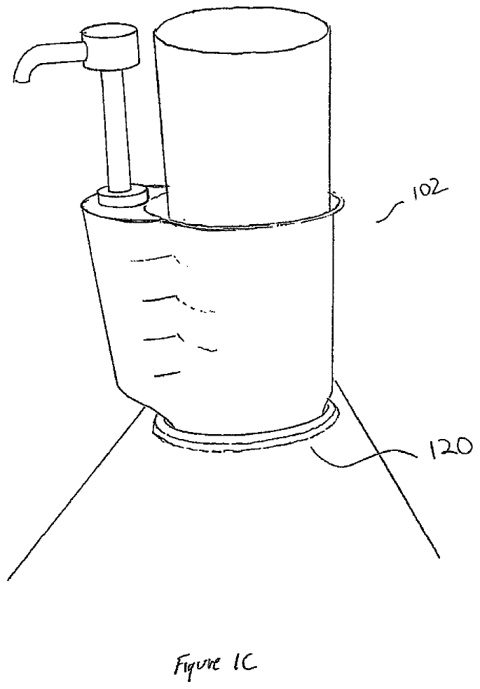

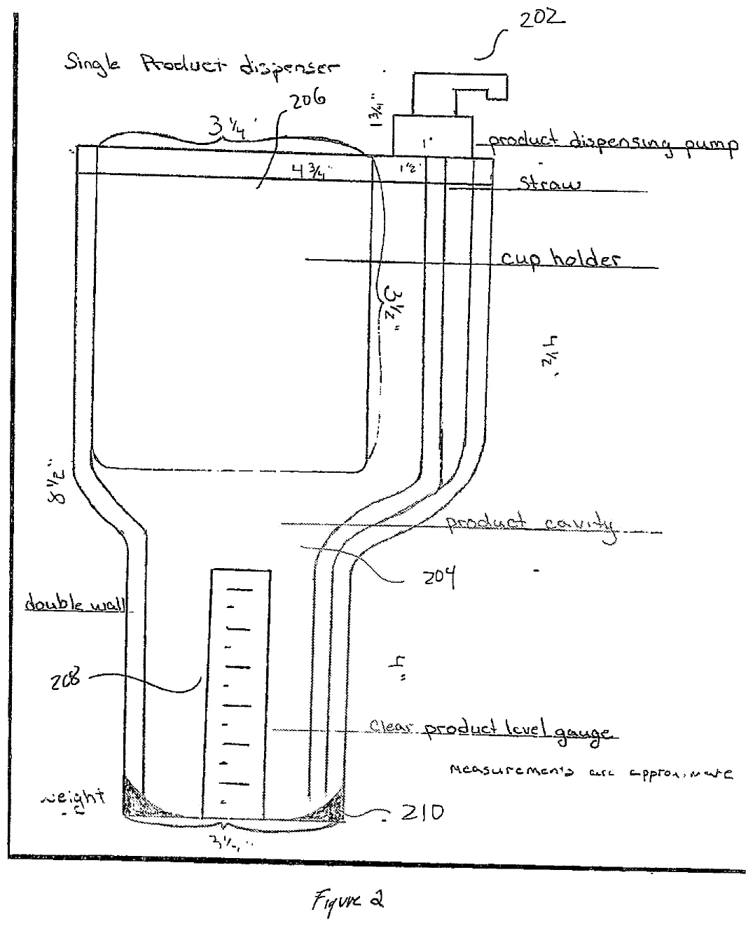

FIG. 2 shows a cross-section view of one implementation of the currently disclosed personal-care-solution dispensing container. In addition to the dispensing pump and pump handle 202, solution reservoir 204, and cup holder 206, this implementation also includes a clear or translucent window 208 that allows a user to determine the amount of solution remaining in the reservoir. In addition, the lower portion of the personal-care-solution dispensing container, in certain implementations, is weighted 210 to facilitate stable anchoring of the personal-care-solution dispensing container in an automobile cup holder or other type of cupholder. In alternative implementations, foam pads, foam inserts, and/or other foam items are used to ensure a stable, snug fit within a cup holder or other receptacle or fixture within an automobile. Dimensions are shown in FIG. 2 for the illustrated implementation, but, of course, alternative implementations may have different dimensions and shapes.

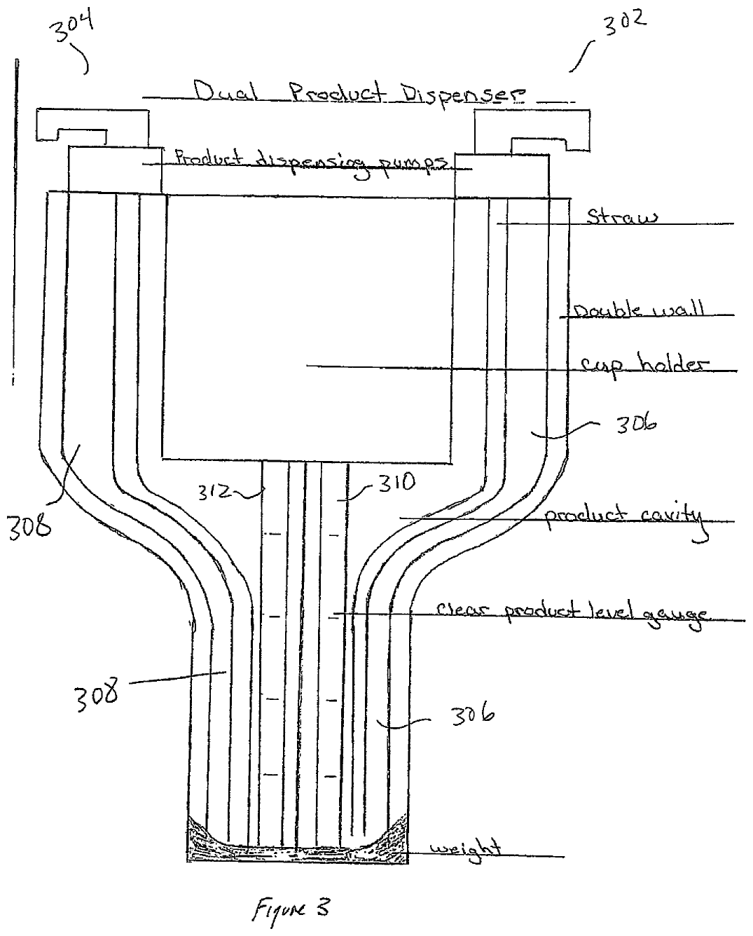

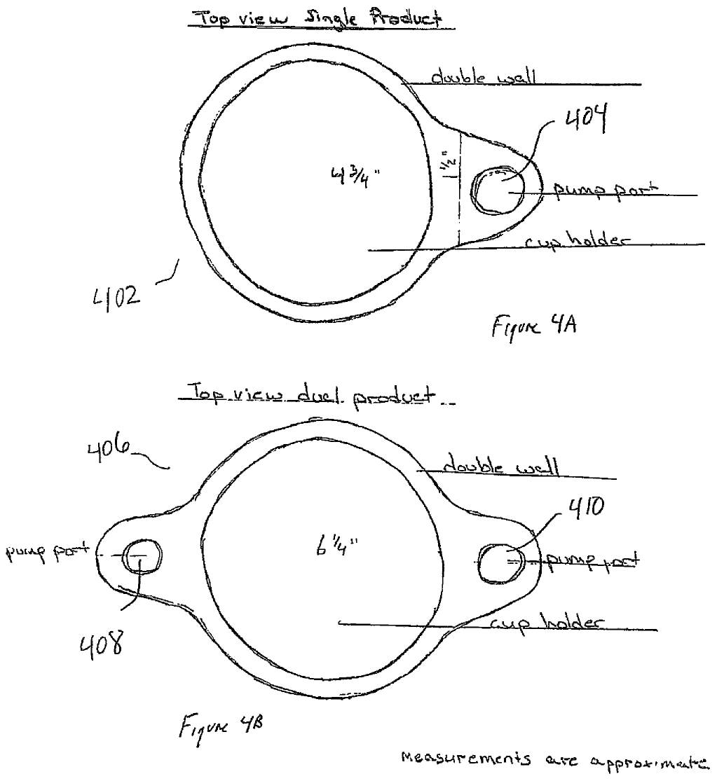

FIG. 3 shows a multi-solution implementation of the currently disclosed personal-care-solution dispensing container using the same illustration conventions as wed in FIG. 2. In this implementation, there are two dispensing pump assemblies 302 and 304, two different associated reservoirs 306 and 308, and two clear or translucent windows 310 and 312 to allow a user to determine the amount of liquid remaining within the two reservoirs. Dimensions are shown in FIG. 3 for the illustrated implementation, but, of course, alternative implementations may have different dimensions and shapes.

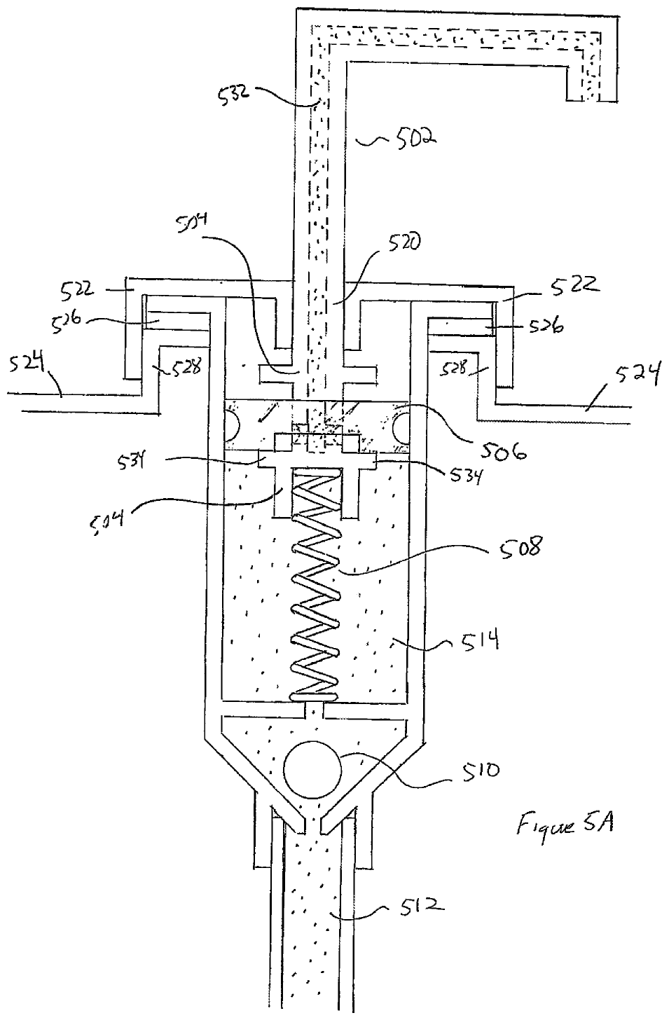

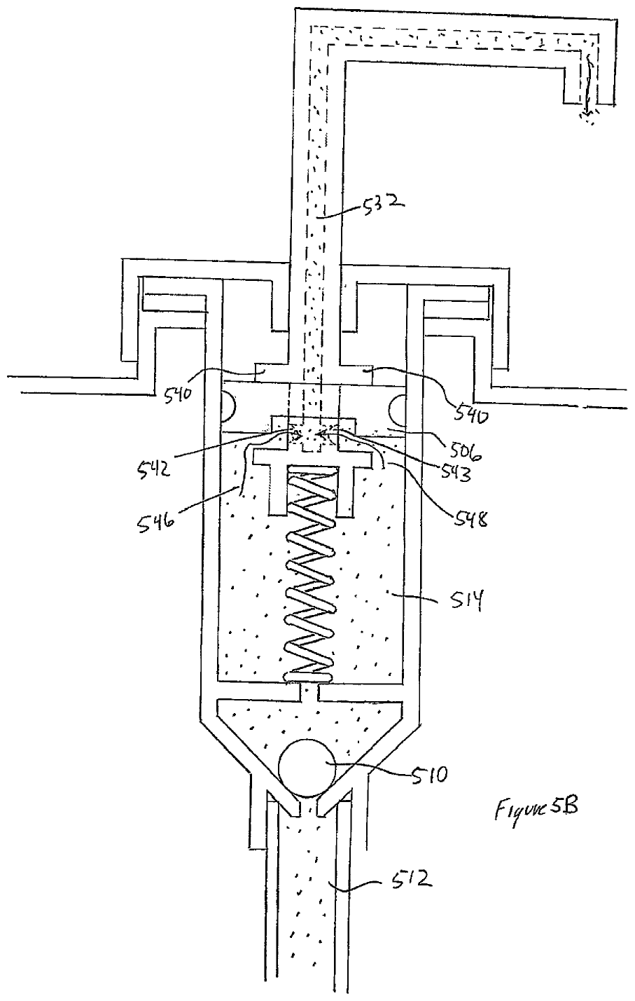

FIGS. 4A-B illustrate the tops of the single-solution and multi-solution implementations of the currently disclosed personal-care-solution dispensing container shown in FIGS. 2 and 3. The single-solution implementation 402 includes a single pump port 404 while the multi-solution implementation 406 includes two pump ports 408 and 410. Dimensions are shown in FIGS. 4A-B for the illustrated implementations, but, of course, alternative implementations may have different dimensions and shapes.

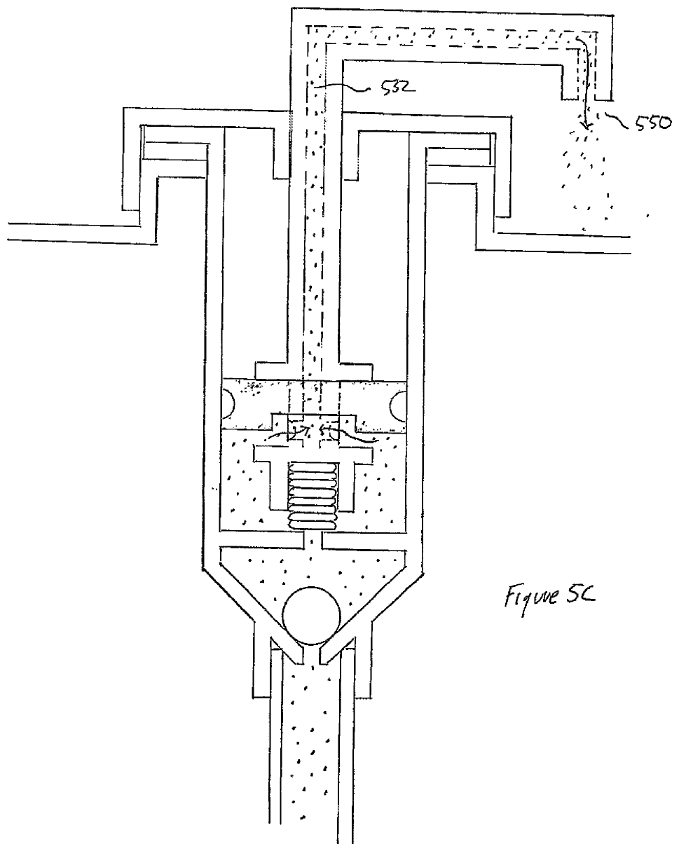

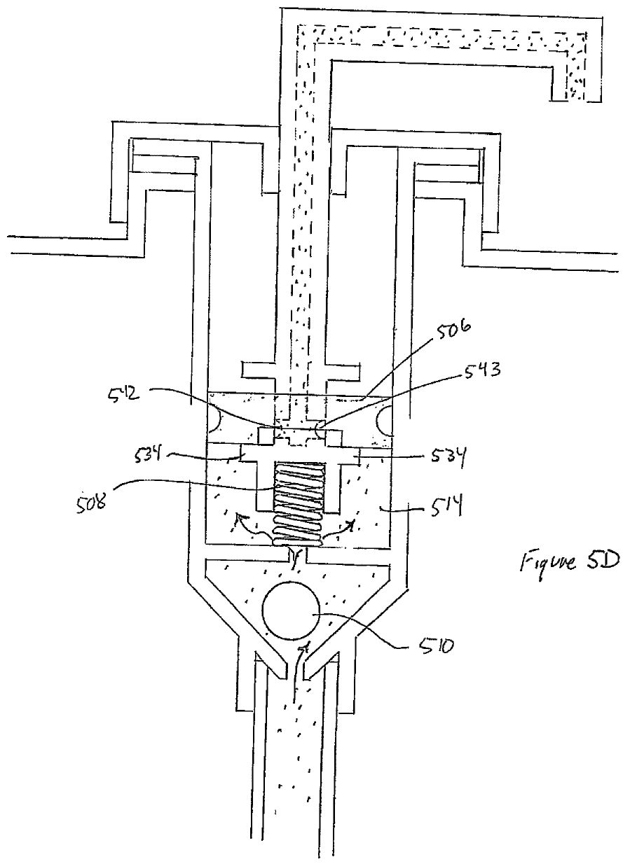

FIGS. 5A-D illustrate operation of the liquid-dispensing pump assembly. The pump assembly is shown in cross-section in FIGS. 5A-D. As shown in FIG. 5A, the pump assembly includes the pump handle 502, a lower pump shaft 504, a tight-fitting piston'seal 506, a coil spring 508, a ball component 510, a solution tube 512 through which solution is drawn from the reservoir, and a pump vessel 514. The pump handle and shaft are mounted within a cylindrical aperture 520 in the center of the threaded cap 522 that secures the pump assembly to the container 524. An annular gasket 526 is compressed when the threaded cap is tightened onto a complementary threaded mount 528 that extends upward from the container to seal the pump vessel from the external environment. In FIG. 5A, the pump assembly is in an already primed, resting state. The pump vessel 514 is filled with liquid as is a channel 532 within the pump shaft and handle and the solution tube 512. A lower flange 534 of the pump shaft is pushed upward into the piston 506 so that there is no communication between the fluid in the vessel 514 and the fluid in the pump-shaft channel 532. The pump shaft and handle are held in position by the coil spring 508.

FIG. 5B shows the pump assembly when a user begins to press down on the on the pump handle. The pump handle has descended vertically to a point that an upper flange 540 of the pump shaft is now flush with the upper surface of the piston 506 exposing several channels 542-543 in the side of the pump shaft to the liquid within the pump vessel 514. As indicated by arrows 546 and 548. solution begins to flow from the pump vessel 514 into these channels, which connect the liquid in the vessel with the shaft channel 532. At the same time, the ball component 510 is forced downward to close off the pump vessel from the solution tube 512. As shown in FIG. 5C. when the pump handle is pressed downward by a user, solution is forced from the pump vessel into the pump-shaft channel 532 and is expelled from the pump outlet 550. As shown in FIG. 5D, just after the user releases the pump handle. the pump shaft is forced upward by the compressed coil spring 508 so that the lower flange 534 again seals off the channels 542 and 543. As the compressed coil spring expands upward and forces the piston 506 upward solution is drawn out of the reservoir and up into the pump vessel 514, with the ball component 510 now displaced from the aperture connecting the pump vessel with the solution tube. Ultimately, the pump assembly returns to the resting position shown in FIG. 5A.

Although the present invention has been described in terms of particular embodiments, it is not intended that the invention be limited to these embodiments. Modifications within the spirit of the invention will be apparent to those skilled in the art. For example, in certain implementations, the cupholder of the currently disclosed personal-care-solution dispensing container is double-walled, for insulation. In another implementation, the cupholder may be single walled. In certain implementations, the personal-care-solution dispensing container may include pressure-relief apertures ports on the top surface. Various different styles and types of pump handles may be used, including pump handles of various lengths. Certain implementations of the personal-care-solution dispensing container may include additional drip-tray features and other features for added convenience. Certain implementations of the personal-care-solution dispensing container may include an electronic pump, rather than a hand-operated pump, with either a rechargeable battery or power-supply plug and adapter for connecting the electronic pump to the vehicle power supply and with buttons and/or motion sensors for activating the electronic pump. Alternative implementations of the currently disclosed personal-care-solution dispensing container may have a variety of different shapes and sizes. For example, the bottom portion of the personal-care-solution dispensing container may have circular, elliptical, or more complex cross sections in alternative implementations, the dimensions of the different portions of the personal-care-solution dispensing container may vary in alternative implementations, the materials used to implement the personal-care-solution dispensing container may vary in alternative implementations, and the surface texture, rigidity, and frictional coefficient of different portions of the personal-care-solution dispensing container may vary in alternative implementations.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus. the present disclosure is not intended to be limited to the embodiments shown herein but is to be accorded the widest scope consistent with the principles and novel features disclosed herein.

1. A personal-care-solution dispensing container comprising:
a bottom portion, shaped to fit within a cavity, that includes a liquid reservoir;
a pump assembly that is operated to pump liquid from the liquid reservoir; and
a cupholder.

2. The personal-care-solution dispensing container of claim 1 wherein the cavity is a cupholder in an automobile, airplane, train, or other vehicle.

3. The personal-care-solution dispensing container of claim 1 wherein the cavity is an accessible cavity, volume, or aperture within a space that can be occupied by one or more persons.

4. The personal-care-solution dispensing container of claim 1 wherein the pump assembly comprises:
a dispenser outlet:
a plunger-type liquid-dispensing pump handle; and
a pump shaft containing a channel through which liquid passes from the reservoir to the dispenser outlet, the pump shaft vertically translated when a downward force is applied to the pump handle.

5. The personal-care-solution dispensing container of claim 4 wherein the pump assembly is removably affixed to the container and cup holder by a threaded cap, with an upper portion of the pump shaft above the threaded cap exposed to the external environment and a lower portion of the pump shaft contained within the pump assembly.

6. The personal-care-solution dispensing container of claim 5 wherein the pump assembly further comprises:
a lower portion of the pump shaft within an upper pump vessel formed by the underside of the threaded cap and interior walls of the pump assembly, the lower portion of the pump shaft having an upper flange, a lower flange, and apertures that interconnect the upper pump vessel with the pump-shaft channel;
a piston/seal through which the lower portion of the pump shaft passes, the piston/seal located between the upper and lower-pump-shaft flanges, the piston/seal translated downward when the downward force is applied to the pump handle. which pushes the upper flange down onto the piston seal, in turn pushing liquid contents of the upper pump vessel into the exposed pump-shat apertures and upward into the pump-shaft channel.

7. The personal-care-solution dispensing container of claim 6 wherein the pump assembly further comprises:
a ball component in a lower pump vessel connected to the upper pump vessel by a first aperture and connected to a solution tube leading to the reservoir by a second aperture, the ball component sealing the second aperture when the downward force is applied to the pump handle to prevent liquid in the upper pump vessel from being forced back into the solution tube.

8. The personal-care-solution dispensing container of claim 6 wherein, following application of the downward force to the pump handle, when the pump hand is released. a coil spring at the bottom of the upper pump vessel forces the pump shaft upward, pushing the lower flange onto the piston/seal. covering the pump-shaft apertures, and drawing liquid from the solution tube into the lower pump vessel through the second aperture and from the lower pump vessel into the upper pump vessel through the first aperture.

9. The personal-care-solution dispensing container of claim 5 wherein the threaded cap is unscrewed to allow the pump assembly to be removed from the personal-care-solution dispensing container to allow for refilling of the reservoir.

10. The personal-care-solution dispensing container of claim further including a second pump assembly and a second reservoir.

11. The personal-care-solution dispensing container of claim 1 wherein the cavity is adapted to firmly mount the personal-care-solution dispensing container using one or more of:
a foam sleeve;
a rigid cup-like adapter;
one or more foam pads; and
a mechanical adapter with mechanical features.

12. A method that dispenses personal care solutions. the method comprising:
comprising:
filling a personal-care-solution dispensing container, the personal-care-solution dispensing container including
a bottom portion, shaped to fit within a cavity, that includes a liquid reservoir,
a pump assembly that is operated to pump liquid from the liquid reservoir, and
a cupholder;
mounting the personal-care-solution dispensing container in a cavity; and
operating the pump assembly to dispense a personal-care-solution.

13. The method of claim 12 wherein the cavity is one of:
cupholder in an automobile, airplane. train, or other vehicle; and
an accessible cavity, volume, or aperture within a space that can be occupied by one or more persons.

14. The method of claim 12 wherein the pump assembly comprises:
a dispenser outlet;
a plunger-type liquid-dispensing pump handle; and
a pump shaft containing a channel through which liquid passes from the reservoir to the dispenser outlet, the pump shaft vertically translated when a downward force is applied to the pump handle.

15. The method of claim 14 wherein the pump assembly is removably affixed to the container and cup holder by a threaded cap, with an upper portion of the pump shaft above the threaded cap exposed to the external environment and a lower portion of the pump shaft contained within the pump assembly.

16. The method of claim 15 wherein the pump assembly further comprises:
a lower portion of the pump shaft within an upper pump vessel formed by the underside of the threaded cap and interior walls of the pump assembly, the lower portion of the pump shaft having an upper flange, a lower flange, and apertures that interconnect the upper pump vessel with the pump-shaft channel;
a piston/seal through which the lower portion of the pump shaft passes, the piston/seal located between the upper and lower-pump-shaft flanges, the piston/seal translated downward when the downward force is applied to the pump handle, which pushes the upper flange down onto the piston/seal, in turn pushing liquid contents of the upper pump vessel into the exposed pump-shat apertures and upward into the pump-shaft channel.

17. The method of claim 16 wherein the pump assembly further comprises:
a ball component in a lower pump vessel connected to the upper pump vessel by a first aperture and connected to a solution tube leading to the reservoir by a second aperture, the ball component sealing the second aperture when the downward force is applied to the pump handle to prevent liquid in the upper pump vessel from being forced back into the solution tube.

18. The method of claim 16 wherein, following application of the downward force to the pump handle, when the pump hand is released, a coil spring at the bottom of the upper pump vessel forces the pump shaft upward, pushing the lower flange onto the piston seal, covering the pump-shaft apertures, and drawing liquid from the solution tube into the lower pump vessel through the second aperture and from the lower pump vessel into the upper pump vessel through the first aperture.

19. The method of claim 15 further comprising:
unscrewing the threaded cap: and
removing the pump assembly from the personal-care-solution dispensing container to allow for refilling of the reservoir.

20. The method of claim 12 further comprising adapting the cavity to firmly mount the personal-care-solution dispensing container using one or more of:
a foam sleeve;
a rigid cup-like adapter:
one or more foam pads; and
a mechanical adapter with mechanical features.
